(19) United States
(12) Patent Application Publication
(10) Pub. No.: US 2009/0210509 A1
(43) Pub. Date: Aug. 20, 2009

(54) Interruption Management

(76) Inventor: Kevin I. Plumpton, Auckland (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/033,196

(22) Filed: Feb. 19, 2008

(30) Foreign Application Priority Data
Feb. 19, 2007 (NZ) 553310

(51) Int. Cl. G06F 15/16; G06F 17/30

(52) U.S. Cl. 709/207; 707/3

(57) ABSTRACT

The present invention relates to a method, system 1 and/or software 20a for handling interruptions. Input defining a project 61 is received along with an associated user availability 66 for that activity and/or associated people 62d. The current activity of a user can be determined, and optionally the status of the corresponding project 66 and associated people 62d. The status 66 can be broadcast to the network, and an interruption can be handled based on the status 66 and associated person 62d.

### FIELD OF THE INVENTION

The present invention relates to a system, software and method for handling interruptions.

### BACKGROUND TO THE INVENTION

Due to the fast pace of work these days, along with the large number of means by which people can communicate, interruptions are common place. In a typical office or other work environment, interruptions take place constantly throughout a worker's day. For example, while carrying out work tasks at a workstation, which might include using the computer, a worker is frequently interrupted by work colleagues, clients and other people in a number of ways. For example, they can be physically interrupted by the person approaching them, or they can be interrupted by a communications means such as email, instant messaging, telephone or the like.

It is well documented that interruptions are very disruptive to the productivity of workers. Even after the actual interruption has finished, it can take many minutes for the interrupted person to return to their original task, regain their thought train and carry on productively in completing that task. Even very short interruptions can be very disruptive to productivity.

### SUMMARY OF INVENTION

Is it an object of the present invention to manage a person's interruptions.

In one aspect the present invention may be said to consist in a method of indicating an availability of a computer user while carrying out an activity comprising the steps of: receiving input defining a project and an associated user availability for that activity, determining a current activity being undertaken by a user, determining the user availability for the current activity, and providing an availability status of the computer user for inspection by other people.

Preferably the determined current activity corresponds to a project.

Preferably the current activity is determined from one or more of: a computer application being used and/or a document opened in that application, an email, a task identified by the user, a current calendar item.

Preferably the current activity is determined from a document title that is currently opened.

Preferably the user availability is determined by obtaining the user availability defined for project corresponding to the current activity.

Preferably providing a user availability comprises showing, upon receiving a request from another person on computer networked to the user computer, a label indicating user availability corresponding to the determined user availability.

In another aspect the present invention may be said to consist in method of managing interruptions received by a user of a computer, the user having one or more defined user projects and one or more people associated with each project, the method comprising the steps of: receiving input indicating an interruption from an interrupter, determining a current activity of the user, determining if there are one or more defined user projects that correspond to the current activity and that are associated with the interrupter, and if so, allowing the interruption to reach the user.

Preferably the invention further comprises prior to receiving input indicating an interruption, receiving input defining one or more projects and one or more people associated for each project.

Preferably receiving input indicating interruption comprises receiving, or receiving an indication of, a telephone call, instant message, and/or email.

Preferably determining if there are one or more defined user projects that are associated with the interrupter comprises determining the identity of the interrupter and checking the user's defined user projects for any user defined projects associated with that identity.

Preferably allowing the interruption comprises allowing the telephone call to pass to the User's telephone and/or notifying the user of an instant message and/or email.

Preferably the invention further comprises not allowing the interruption to reach the user if it is determined that the interrupter is not associated with any of the projects relating to the current activity.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

The term “comprising” as used in this specification means “consisting at least in part of”. Related terms such as “comprise” and “comprised” ate to be interpreted in the same manner.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting

### BRIEF DESCRIPTION OF THE DRAWINGS

Preferred embodiments of the invention will be described with reference to the following drawings, of which:

FIGS. 1 and 2 are block diagrams of a system according to one embodiment,

FIGS. 3 to 5 are flow diagrams showing a method according to one embodiment,

FIG. 6a to 6f are screen shots showing a user defining a project,

FIG. 7 is a screen shot showing the presence states of various users, and

FIG. 8 is a flow diagram showing call blocking in further detail,

### DETAILED DESCRIPTION OF PREFERRED EMBODIMENTS

Preferred embodiments of the invention will be described with reference to the drawings. In general terms, the invention relates to a system, software and/or method that allows a user of a computer on a network to indicate their presence status, state or availability and update it automatically by user's project. This state can be viewed by others when determining whether or not to interrupt the user and/or by the system/software in determining whether or not to allow interruptions. Presence state, status or availability are interchangeable terms. They refer to the current availability of the user of the system. A current availability could be a simple as “available” or “not available”. A larger range of availabilities might exist. For example, a status could be one or more of: available, in a meeting, gone out, do not disturb, away on business, away on leave, on sick leave or any other suitable availability. This list should not be considered exhaustive. In each case, the availability will provide some indication as to whether or not the respective person can be interrupted.

The software that implements the method can be installed on one or more computers in a computer system. The computer system might comprise one or more components such as computers, databases and networks and servers.

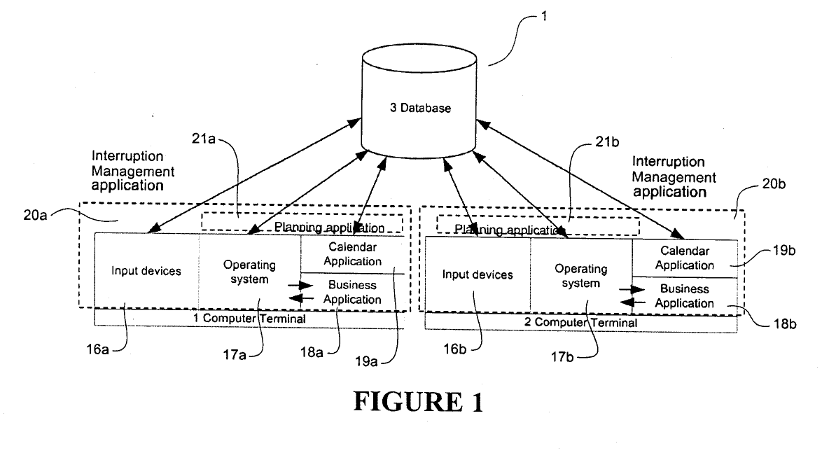

FIG. 1 shows one possible embodiment of a computer system 1 that operates software to carry out the method of the present invention. The computer system comprises two computer terminals 1, 2 that are networked together and also share a networked database 3. The computers are used by workers in an office environment, or any other people who carry out tasks and could benefit from interruption management. Generally, each computer allows the respective user to indicate their availability and control incoming interruptions. It also allows a respective user to indicate their availability status to other users on the network so those users can determine appropriate times to make interruptions. A computer user can be both an interrupter (the one doing the interruption) or an interruptee (the one being interrupted). Interruptions can take place in any form, such as a physical approach, telephone call, instant message, email or any other suitable communication means. Interruptions typically occur when one worker or computer user wishes to communicate with another worker regarding some matter, that may or may not be relevant to the interruptee and may or may not be of current importance to the interuptee.

Each computer terminal 1, 2 comprises one or more input devices 16a, 16b, an operating system 17a, 17b and one or more business applications that are generally indicated 18a, 18b. Business applications might be, for example word processing applications, spreadsheet applications, email client applications, and web browsers. Any other suitable applications could be provided, and this list is by way of example only. Each computer 1, 2 also comprises a calendar application 19a, 19b and a project planning application 21a, 21b. Activities can be projects, tasks, goals or any other defined activities that the computer user wishes to carry out.

Each computer terminal 1, 2 also comprises an interruption management application software module 20a, 20b that allows for the defining of projects along with associated people and presence states for those projects. This information can then be used and transferred across the network to allow for interruption management. The interruption management application 20a, 20b allows the user to enter project information and review statuses of others on the network, and allows computer to control interruptions and whether or not to allow those interruptions through to the interruptee. The interruption management application 20a, 20b might comprise the project planning application 21a, 21b, or these may be separate.

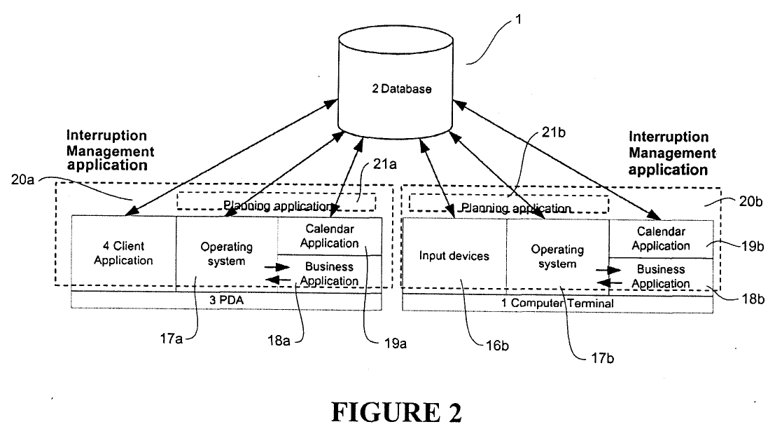

FIG. 2 shows an alternative embodiment of the system. The network comprises computer terminal 1 and a personal digital assistant (PDA) 3 that can also be used to enter project information. It comprises the same software and hardware as the computer terminal, such as operating system, calendar application and business applications. It also comprises a client application 4 for a user interface and interaction with the network. It also includes as part of client application the interruption management application. The interruption management applications 20a, 20b allow for defining project, or projects could be defined using another application on the computer 1, 2.

It would be appreciated by those skilled in the art that methods for defining projects could vary greatly. The present invention as described here could be effective with any number of computer terminals and databases and any number of network configurations, along with any number of different types of user interfaces. The present invention is not limited to the various arrangements described herein.

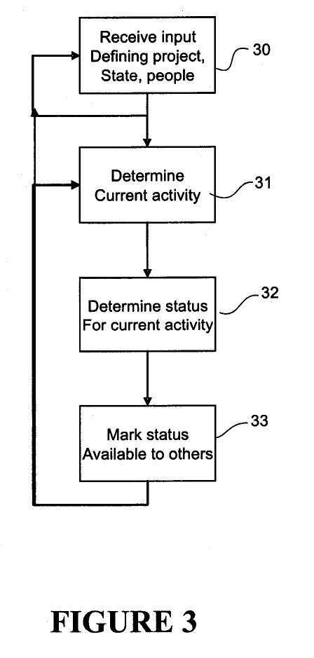

An overview of the invention will be described with reference to FIG. 3. FIG. 3 shows the method of a possible embodiment from the perspective of the interruption management application 20a. It will be appreciated the application 20b functions in the same manner. The description will now refer to computer 1, but it will be appreciated that the same description relates to any computer that forms part of the system 1. First, the application 20a receives input defining projects, along with states associated with that project and people associated with that project, step 30. A number of such projects can be defined at any suitable time by the user of the respective computer 1. The status will relate to the presence or availability of the user when working on that project. The person defining the project can also define one or more people associated with that project, for example being people that are working on that project also or having some involvement or association with the project. Projects can be defined periodically as and when required.

At periodic or continuous times, or when triggered, the interrupt application 20a will determine the current activity of the user of that computer at any particular time, step 31. The current activity may relate to a particular project that the user is working on at that time, or alternatively a project that is in progress at that time even if the user is not actually working on it at that point in time. The current activity can be determined by the interrupt application 20a in a number of ways to be described in full later, such as by looking at the application, email or calendar items being worked on at any particular time by the computer user. The current activity will correspond to a previously defined project (assuming the worker is working on a matter that relates to a project).

The computer then determines the status for that current activity, step 32, by looking at the state defined for the corresponding project. The computer application 20a then makes that determined status available to others on the network for them to check. This means that at any particular time, a computer user on the network will have a current status based on the current activity determined by their interruption application 20a. If another user on the network wishes to interrupt a particular user, they can check on their current status or availability via the network, step 33. A potential interrupter may make a decision not to interrupt/or to interrupt based on the broadcast status of the user they wish to interrupt.

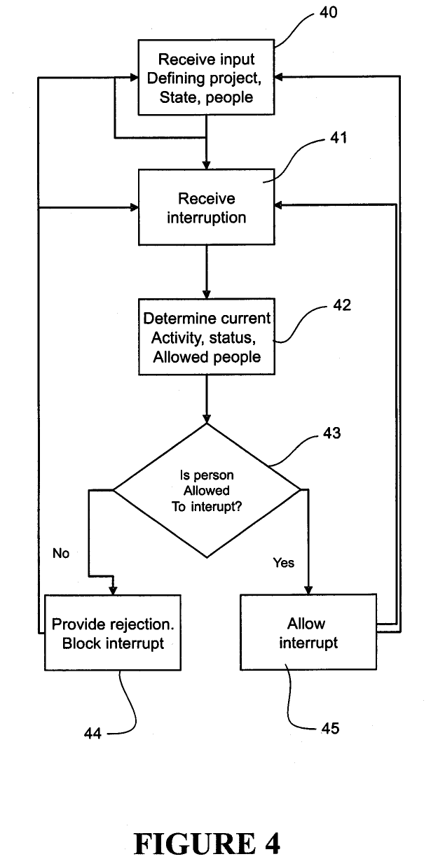

FIG. 4 shows from an interruption application 20a perspective how the status may be used to control interruptions reaching the interruptee. Again, the computer interruption application 20a will periodically or continuously receive input from a user defining various projects, and a respective status or availability for each of those projects and people associated with each of those projects, step 40. The application 20a will then continuously poll or monitor for interruptions, for example via telephone, email or instant messaging from another user on the network, step 41. It will determine the identify of the interrupter.

The application 20a then determines the current activity of the interruptee, the corresponding project, the state related to that project, and the people associated with that determined current activity, step 42.

The interruption management application 20a then determines whether the interrupter should have their communication passed on to the interruptee, step 43. This will be based on a number of factors. First, if the current state of the interruptee is “available” or some other status that indicates that the user is available for interruption, then the interruption management application will allow the interrupt to pass through, step 45 to the interruptee. This might be by way of allowing a telephone call through and allowing the telephone to ring, allowing an email notification to sound, or allowing an instant message window to pop up. It will be appreciated that allowing the interruption will take place in any suitable manner in relation to the communication means being used.

If the current status is one indicating that the interruptee does not want interruptions, or may not want interruptions, step 42, then the computer may or may not allow the interruption through. If the interruption status indicates that the interruptee should not be disturbed, but the interrupter is one of the people associated with the project relating to the determined current activity of the interruptee, then the interruption management application will allow the interruption through, step 43, 45 as described earlier. In some cases it may be defined that the interrupter is only allowed through if the communication is indicated as being urgent by the interrupter.

If the status for the determined current activity indicates that the interruptee should not be disturbed (such as “not available”, “do not disturb” or some other suitable availability status) and the project relating to the current activity they are working on is not associated with the interrupter, then the interruption management application 20a will not allow the interruption to occur. This might be by way of blocking a telephone call, not allowing an email through, or alternatively allowing an email through but not providing a notification, or not providing an instant message dialogue window and/or notification. Again, the manner in which an interruption will be blocked will be dependent on the nature of the interruption communication means. In an alternative method, the interruptee may be provided with some indication that an interruption has been attempted, by way of voice mail, email or other message. Optionally, the interrupter may be advised that their interruption has been blocked, by way of a instant message, email, dialogue pop up box, or voicemail message, or any other suitable means depending on the communication means used to make the interruption.

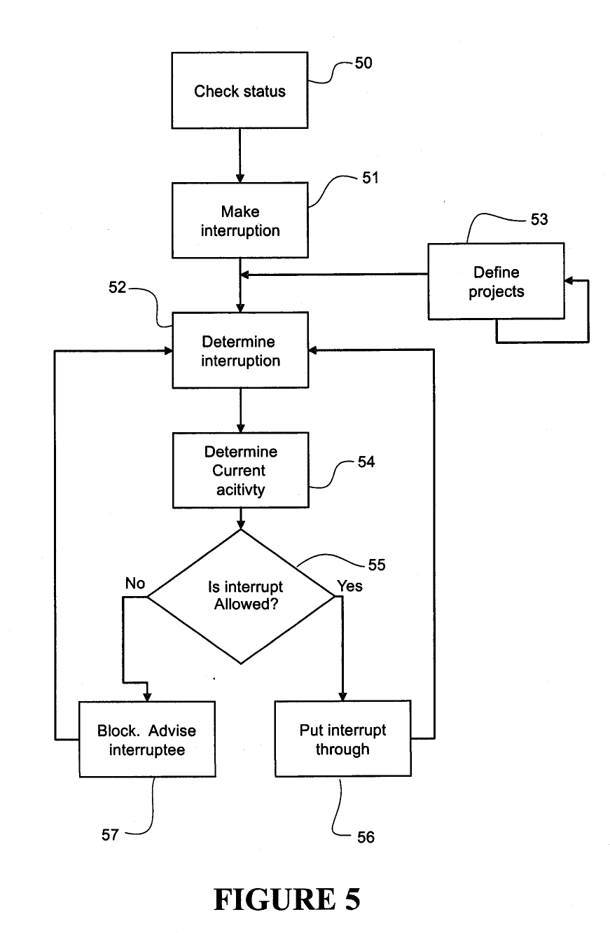

FIG. 5 shows in general the process that takes place. The interrupter may or may not first check the status of the person they want to interrupt by looking at their availability on the network, step 50. This can be determined and provided as described in relation to FIG. 3. The interrupter may then, based on the status, decide to proceed with an interruption, or if they have not checked the status may make or attempt to make the interruption regardless, step 51. In parallel with this or beforehand, the interruptee will have defined a number of projects, step 53, and defined an availability status or presence status, and people associated with those projects. Once the interrupter has attempted to make the interruption, the interruptee's computer will determine that an interruption is taking place, step 52. It will then determine the current activity of the interruptee, and the project associated with that current activity. As described previously, the current activity may be a specific activity being worked on, or a project or other activity that is ongoing even if not being currently worked on, step 54. In addition to determining the current activity, the computer determines the project related to that current activity, the status defined for that project and associated people defined for that project. In step 55, the computer then determines whether the interruption is allowed, as described previously in relation to FIG. 4. If the interruption is not allowed, the interruption will be blocked in a suitable manner, step 57, as described previously.

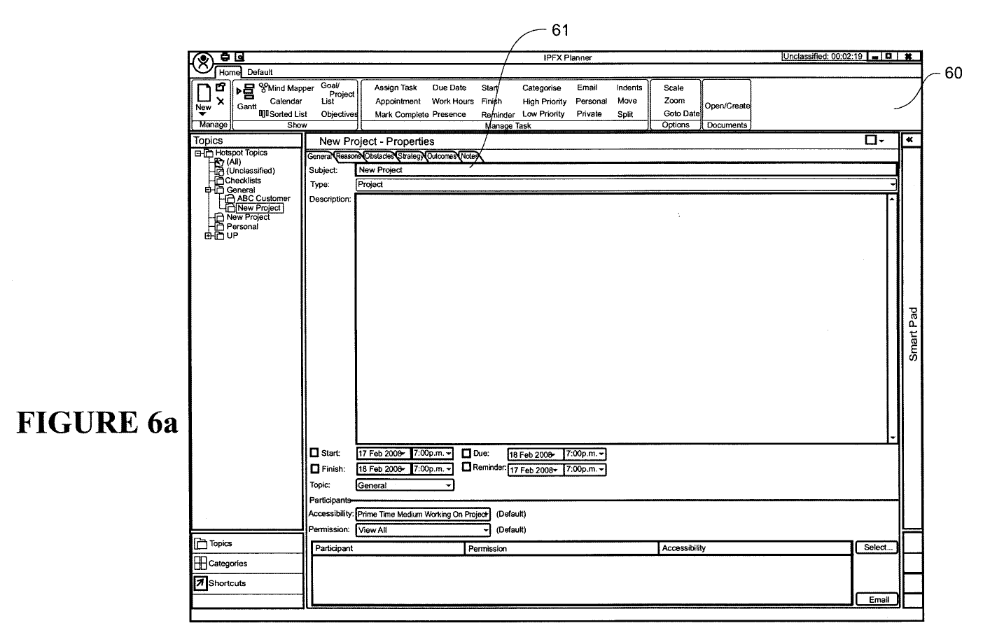

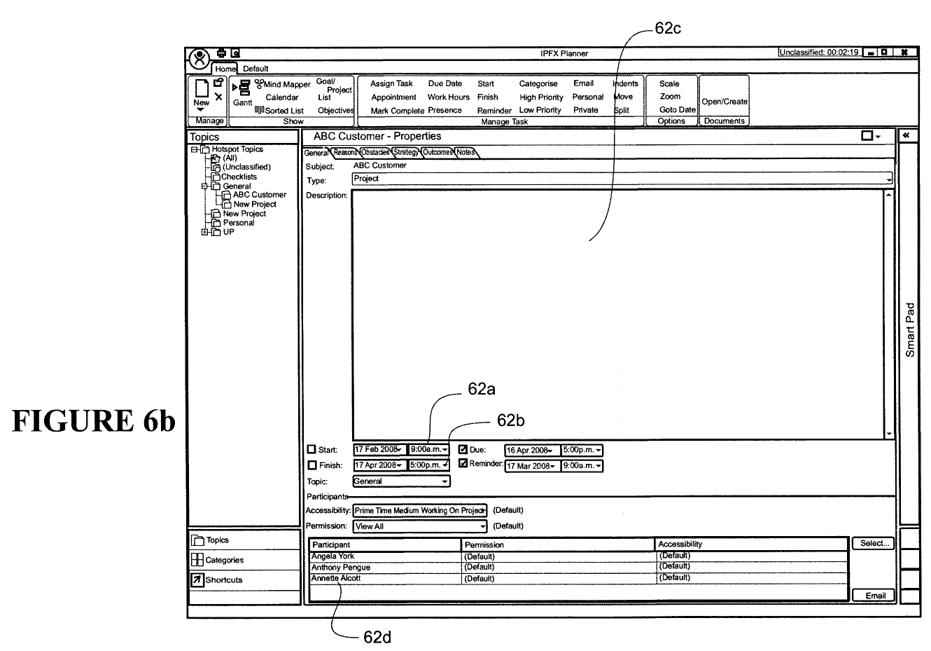

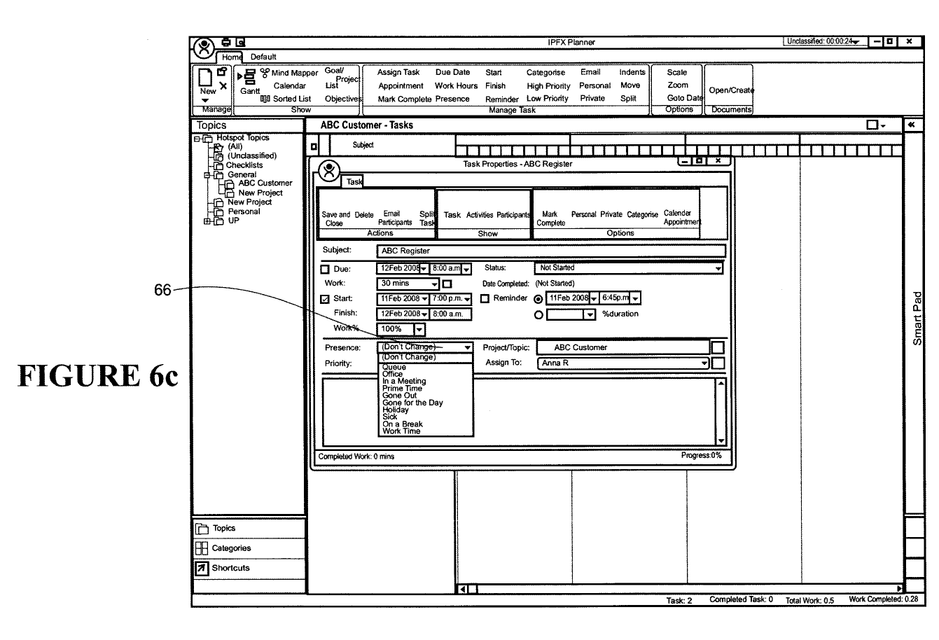

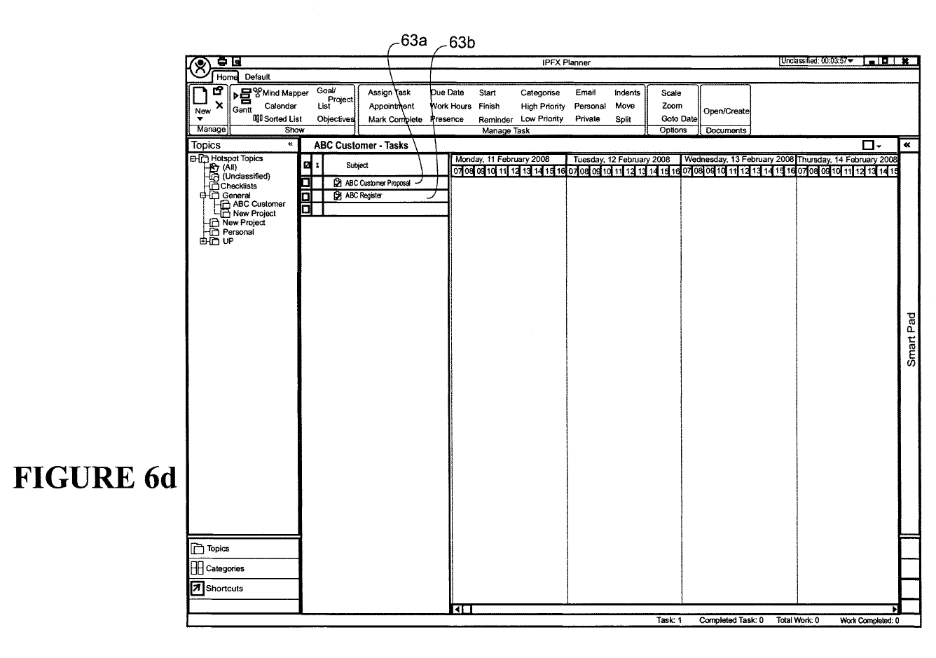

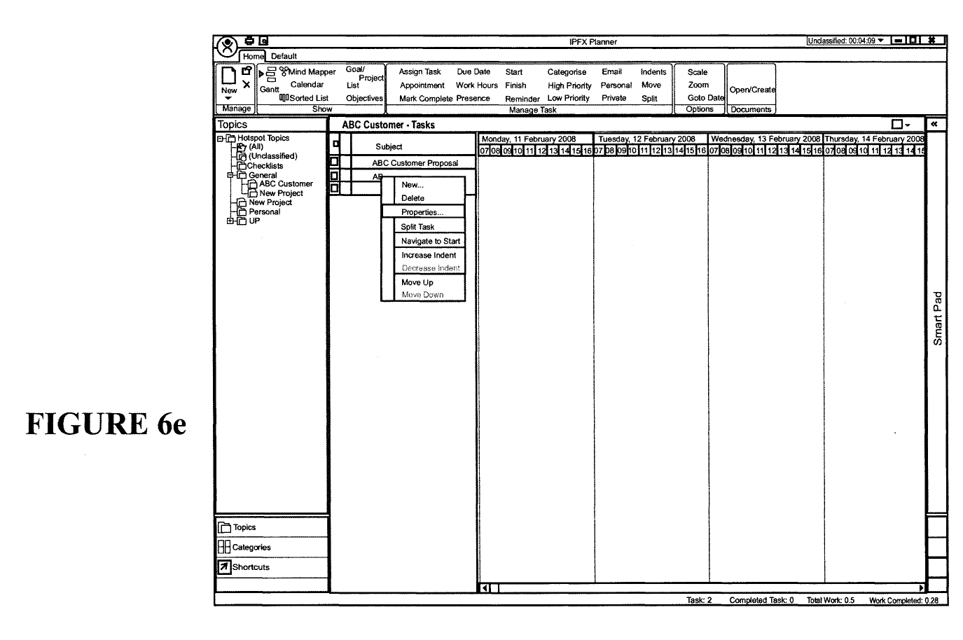

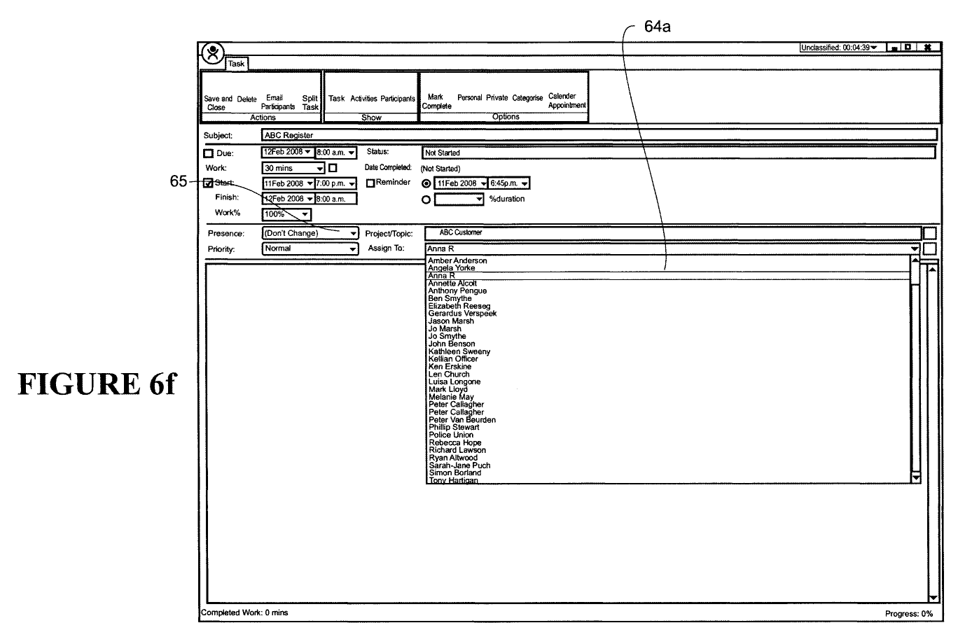

The method for defining projects will be described in further detail with reference to FIGS. 6a-6f As mentioned previously, projects can be defined by anyone on the network using their interrupt application 20a or any other suitable application. A project can generally be defined in relation to any project, goal, task or other activity that the user may wish to undertake as part of their work. The information defined in the project can be used for any number of suitable purposes as part of the work processes, in addition to being used for handling interruptions in the present invention. All these possible activities that can be defined will generally be termed “projects”. A project can be defined as having a number of sub parts, such as tasks which might go towards defining or making up the various activities required to complete the project. The term “project” can therefore be generally mean the project, goal, or task itself, or any sub-project, sub-goal, or sub-task. Projects can be continuously or periodically defined by the user of a computer, as and when required.

A project is set up in the following way. Referring first to FIG. 6a, the user opens up an appropriate project creation window 60 and enters a project name or subject in the required field 61. Referring to FIG. 6b, the user can then define a number of attributes or parameters relating to that project, including start and finish dates 62a, 62b, comments or descriptions 62c and any other necessary information for that project.

A presence status or availability can be defined generally for the entire project 66, see FIG. 6c. This can indicate the availability of the user when they are engaged in this project, and this may indicate that they are available for interruption or not available for interruption at that time. For example, the project may have one or more of the following availabilities or presence states 1) Available, 2) In a meeting, 3) Gone out, 4) Do not disturb, 5) Away on business, 6) On leave. Other presence states are possible, and these are described by way of example only.

The user can also define one or more participants, being associated people, that are involved with the project or have some association with the project 62d. Among other things, the participant may have better access rights to interrupt the user when they are working on the project, as will be described later.

Referring to FIG. 6d, the user can then define a number of sub-projects or sub-tasks of that project, being various activities or other matters that go towards making up the project. In this case, the project has two sub-tasks defined being “abc customer proposal”, and “abc register” 63a, 63b. Each of these tasks can individually have participants or associated people assigned to them as shown in FIG. 6e, 6f. Here it can be seen that the task abc register has had the person “Anna R”associated with it 64a. Again, each task could have a presence status or availability 65 assigned to it depending on the availability of the user when carrying out that task of the project. This may or may not override the general availability assigned to the project, depending on the circumstances and the user settings. A general project might not have an availability assigned, in which case any sub-project availability will apply. An availability can also be manually overridden by the user.

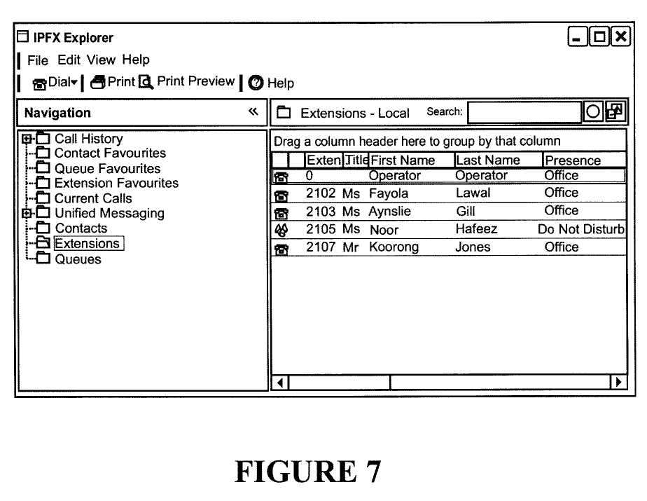

Referring to FIG. 7, when one user (being an interrupter) wishes to call another user being an interruptee they can check the current presence or availability of that person. This can be seen in FIG. 7, where there are a number of users. All but one are in the office and therefore available. Ms Noor is indicated as having the status “do no disturb”. Note, the presence as shown in FIG. 7 is determined by each computer user's interruption application 20a, as will be described later. Another user can then determine whether or not to call one of the people based on their status. If someone tries to make a phone call to Ms Noor (either because they didn't check their status, or because they want to contact Ms Noor regardless) the following happens.

If someone tries to ring Ms Noor, her interruption management application 20a will decide whether the call should be accepted and put through to Ms Noor, based on her current activity, the status of the project associated with the activity and the person calling. In this case her availability is “do not disturb. In this case, only people associated with her project will be allowed through. If a person is not associated with that project her telephone will not ring, and will divert to voicemail. Alternatively, it could divert to another telephone, operator, work associate or the like. The interruption management application optionally could provide a visual indication of this to Ms Noor, and optionally could provide an indication of this to the interrupter by way of computer pop up, email, or instant message, voicemail or any other suitable means. If the person tries to contact Ms Noor via email, her email will go through the inbox but she will not receive notification. If the contact is by instant message, Ms Noor will not receive the pop up window. Optionally, MS Noor may be advised that an attempt for contact via instant message has been made, and the interrupter may receive an indication that their instant message has not been put through. Clearly other alternatives for other communication means could be provided.

The following provides some options on how the interruptee's computer will react to an interruption, once they have determined the current activity of the user, the project associated with that current activity, the status of that project and the people associated with that project.

1. If the availability state is one that indicates the interruptee is available for interruptions, then the interruption will be passed to them in the form of a telephone call, instant message, email or the like in the usual manner.

2. If the availability state is one that indicates the interruptee is not available for interruption, then the computer will decide if the interruptee is one of the people associated with the project related to the current activity. There are two options.

a) If the person is associated and there are no other conditions, then the interruption will be allowed and the email, telephone call, instant messaging will be passed through to the interrupee.

b) If the person is associated, but the interruptee has defined that people associated with the project can only be allowed through if their call is urgent, then something else occurs. If this is the case, then the interruption will only be passed through if the interruptee is an associated person and they have indicated that the telephone call, email or instant message is urgent. They can do this by a suitable setting on their computer or telephone when making the interruption.

It should be noted that the current activity can be determined as the activity the user is working on at the particular time, or project that is currently in progress, even if the user is not working on any particular matter related to the project at that current time. Therefore, a user may have several current activities at any particular time. One or more of these current activities may relate to an actual project they are working on at the particular time. One or more other current activities may relate to projects that are currently in progress, but are not currently being worked on. Therefore, in determining the current activity all such projects are considered, and any interrupter can be passed through if they meet the requirements of any one of those projects that is determined as being one of the current activities.

In this way, an interruptee might be able to define a project such that an associated person will be allowed to interrupt them at any time during the project lifespan, or define that an associated person with that project can only be allowed through when they are actually currently working on a matter relating to the current project. Similarly, where an interruption has been indicated as urgent, an interruptee may have defined that urgent calls can come through from an associated person at any time during the progress of a project, or that an urgent call can only be put through when working on a particular matter at that time relating to a project.

Any combination or permutation of these options is possible.

It should be noted, that any status could also be manually overridden by the user to set one of these requirements as necessary.

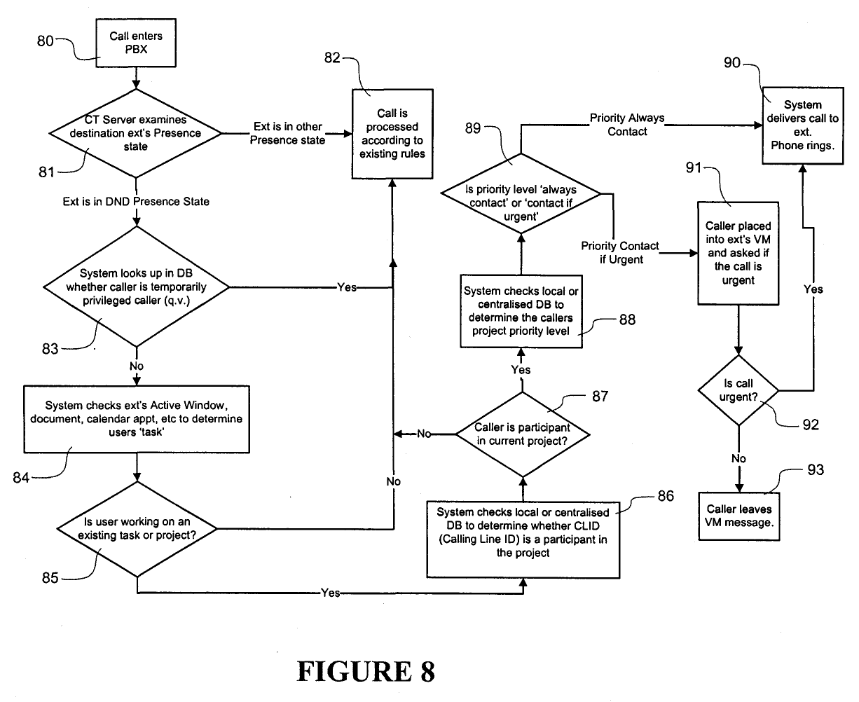

The manner in which the interruption management application 20a determines the current activity, status and allowed people will be described in further detail here with reference to FIG. 8. Determining the current activity, project associated with that activity and corresponding state can be done continually and then broadcast. Alternatively, it can be triggered when an interruption occurs.

First the current activity might be determined from interruption management application or tasks the user is carrying out on the computer at any particular time. More particularly, the interruption application 20a has functionality track all activities the user engages in. The EMS 14 receives communication from all input devices 16a, the operating system 17a, and all business applications 18a signifying events have occurred. The operating system 17a is used to detect: 1) user input from 16a by using Mouse and keyboard hooks, 2) all windows by Enumerating Windows APIs, 3) text in different fields within windows, 4) application names, 5) open files and their directories, 6) registry settings.

Accurately interpreting the user activity requires different techniques for different types of applications used as applications behave differently and may contain multiple activities within them. The system intelligently estimates or determines the current activity and/or classification of that activity.

For example, a user may have open one word processor but several documents each a different activity. Also a user may have open several emails at once also related to different activities. The interruption application processes the following types of information to best determine the activity. It may use any combination of:—

1) Detecting the active Window from the Operating System 17a.

2) Enumerating Windows within the Operating System 17a to obtain and use all active windows.

3) Checking text fields on each window for example to determine the customer name within a service application or the sender of an email or the document or spreadsheet title in Word or Excel or website URL.

4) Using the Operating System 17a to determine active files opened and the directory they are in.

5) Reading the registry to find an applications active filename.

6) Detecting calendar information from a Calendaring application 19a or Business Applications 17a.

7) Business Applications 18a themselves indicating the users current activity.

8) Using Mouse and Keyboard hooks from 16a detected in 17a to be notified of mouse and keyboard activity that allows us to determine actual time on each activity on the computer and/or where the input is focussed. By tracking the activities window time active and setting time to Idle where there is no keyboard or mouse activity for a predetermined time we can calculate time used rather than time open. Optionally Idle time can be used to prompt the user what happened for non-computer activity. For example the user could say they were reading a document related to project X that could be used to set activity to Reading and classify it to project X covered later.

9) After detecting and tracking an activity the application 20a also closes the activity when the associated window is closed.

Examples of how the interruption application 20a may calculate an activity are:

1) finding the active Excel spreadsheet by finding the active window, then finding the owner application is Excel, then looking at the titles of the sub root windows to determine each open spreadsheet. Then detecting the sub window receiving the users input from mouse and keyboard to determine the active spreadsheet and hence user activity.

2) Finding a customer being serviced by finding the active window, then finding the owner application is a particular service application, then looking at a text field in the main window to read the customers name.

Note other options exist using the techniques above and the interruption application 20a is tuned for different techniques per application and types of activities.

As a result of the above, the interrupt application 20a can determine the current activity, and correlate this to a project, which becomes the current project.

Once the project has been identified, the computer can obtain the state defined by the user for that project, along with one or more associated people with that project. The current activity may relate to a sub-project in a project or the overall project.

In addition, a current activity can be determined as any project which is currently ongoing, irrespective of whether the user is currently working on that project as determined above. In this case, one or more current activities may be determined at any particular time.

A particular example of the method can be described in relation to FIG. 8. This relates to a telephone call. When a call enters the PBX, step 80, the server determines the extensions current presence state step 81. If the presence state is one which indicates that the user is available for interruptions, then the call is processed according to existing rules and passed through to the interruptee, step 82. If the state equates to a “do not disturb” presence (i.e. the interruptee is not available to the interrupter) the system looks up into the database to determine whether the caller is a temporarily privileged caller. This might be one where the interuptee is temporarily indicated that the interrupter can interrupt them, irrespective of any other settings, step 83. It might also consider projects that are currently ongoing, step 84. If this is not the case, then the system checks for the current activity of the user, for example by looking at the active window, currently open document, calendar appointments and the like. If the user is working on an existing project that has been defined, step 85, then the system checks the local or centralised database 3 to determine whether the person associated with the call is a participant or as an associated person with the project relating to the current activity, step 86. The CLID is caller line identification. If the caller is not a participant in the project related to the current activity, step 87, then the call is rejected. If the caller is a participant in the project, the system checks the local or centralised database to determine if the call is priority level is acceptable. For example, it checks whether it needs to be an urgent call and has been defined by the caller as being urgent, step 88. If the priority level is “always contact”, step 89, then the system delivers the call to the interruptee and the phone rings, step 90. If the priority level is “contact if urgent”, step 89, then the caller is placed into the interrupter's voicemail and is asked if the call is urgent, step 91. Alternatively, they may indicate that their call is urgent in another way, by entering key presses into the telephone or indicating this on the computer. If the call is urgent, step 92, then the system delivers the phone call to the interruptee and the phone rings in the normal manner, step 90. If the call is not determined as urgent, then the caller can leave a voicemail message, step 93, and the phone is not allowed to ring. Clearly, FIG. 8 relates to a telephone call. A similar process can be followed for any other communication methods.

It will be appreciated that the user can define various status settings when defining a project, and rules on how to deal with interruptions based on those statuses and associated people. For example, in addition, a user can manually set if a certain interrupter's interruption can be put through. Any combination of these can be applied in the present invention.

It should be appreciated that the various steps in the flow charts shown in FIGS. 3 to 5 do not have to be carried out exactly in the order shown. Other orders will be known to those skilled that achieve the goal of handling interruptions based on statuses and/or associated people.

1. A method of indicating an availability of a computer user while carrying out an activity comprising the steps of:
receiving input defining a project and an associated user availability for that activity,
determining a current activity being undertaken by a user,
determining the user availability for the current activity, and
providing an availability status of the computer user for inspection by other people.

2. A method according to claim 1 wherein the determined current activity corresponds to a project.

3. A method according to claim 1 wherein the current activity is determined from one or more of:
a computer application being used and/or a document opened in that application,
an email,
a task identified by the user,
a current calendar item.

4. A method according to claim 1 wherein the current activity is determined from a document title that is currently opened.

5. A method according to claim 1 wherein the user availability is determined by obtaining the user availability defined for project corresponding to the current activity.

6. A method according to claim 1 wherein providing an user availability comprises showing, upon receiving a request from another person on computer networked to the user computer, a label indicating user availability corresponding to the determined user availability.

7. A method of managing interruptions received by a user of a computer, the user having one or more defined user projects and one or more people associated with each project, the method comprising the steps of:
receiving input indicating an interruption from an interrupter,
determining a current activity of the user,
determining if there are one or more defined user projects that correspond to the current activity and that are associated with the interrupter, and if so,
allowing the interruption to reach the user.

8. A method according to claim 7 further comprising prior to receiving input indicating an interruption, receiving input defining one or more projects and one or more people associated for each project.

9. A method according to claim 7 wherein receiving input indicating interruption comprises receiving, or receiving an indication of, a telephone call, instant message, and/or email.

10. A method according to claim 7 wherein determining if there ate one or more defined user projects that ate associated with the interrupter comprises determining the identity of the interrupter and checking the user's defined user projects for any user defined projects associated with that identity.

11. A method according to claim 9 wherein allowing the interruption comprises allowing the telephone call to pass to the user's telephone and/or notifying the user of an instant message and/or email.

12. A method according to claim 7 further comprising not allowing the interruption to teach the user if it is determined that the interrupter is not associated with any of the projects relating to the current activity.
